(19) United States
(12) Patent Application Publication
(10) Pub. No.: US 2024/0411891 A1
(43) Pub. Date: Dec. 12, 2024

(54) SYSTEM AND METHOD FOR ASSESSING CYBER-BASED DATA PROTECTION EXPOSURE USING ARTIFICIAL INTELLIGENCE

(71) Applicant: BANK OF AMERICA CORPORATION, Charlotte, NC (US)

(72) Inventors: Anthony David Lange, Washington, DC (US); Madeline Deneen Fest, Charlotte, NC (US); Adam Kristian King, Fort Mill, SC (US); Tarsha Maria Salley, Charlotte, NC (US); Michael Robert Young, Davidson, NC (US)

(73) Assignee: BANK OF AMERICA CORPORATION, Charlotte, NC (US)

(21) Appl. No.: 18/206,971

(22) Filed: Jun. 7, 2023

(51) Int. Cl. G06F 21/57

(52) U.S. Cl. CPC G06F 21/577; G06F 2221/034

(57) ABSTRACT

Systems, computer program products, and methods are described herein for assessing cyber-based data protection exposure using artificial intelligence. The method includes compiling an assessment of cyber-based data exposure of an entity using artificial intelligence, said entity comprised of a set of cyber-based data, an internal set of cyber-based protective measures, and an external set of cyber-based protective measures. The method further includes comparing the assessment of cyber-based data exposure against an open-source database. The method further includes generating an analysis of cyber-based data protection exposure associated with the entity based on the comparison of the assessment of cyber-based data exposure against the open-source database. The analysis of cyber-based data protection exposure associated with the entity comprises an estimation of exposure of the set of cyber-based data.

### TECHNOLOGICAL FIELD

Example embodiments of the present disclosure relate to assessing cyber-based data protection exposure using artificial intelligence.

### BACKGROUND

Exposure of an entity in terms of cyber-security has been known to cause difficulties to said entity. Understanding and identifying the exposure of an entity may reduce and prevent difficulties associated with the cyber-security of the entity.

Applicant has identified a number of deficiencies and problems associated with assessing cyber-based data protection exposure using artificial intelligence. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for assessing cyber-based data protection exposure using artificial intelligence.

In one aspect, a system assessing cyber-based data protection exposure using artificial intelligence is provided. In some embodiments, the system may comprise: a memory device with computer-readable program code stored thereon; at least one processing device operatively coupled to the at least one memory device and the at least one communication devices, wherein executing the computer-readable code is configured to cause the at least one processing device to perform the following operations: compile an assessment of cyber-based data exposure of an entity using an artificial intelligence, said entity comprised of a set of cyber-based data, an internal set of cyber-based protective measures, an external set of cyber-based protective measures; compare the assessment of cyber-based data exposure against an open-source database; and generate an analysis of cyber-based data protection exposure of the entity based on the comparison of the assessment of cyber-based data exposure against the open-source database. The analysis of cyber-based data protection exposure associated with the entity comprises an estimation of exposure of the set of cyber-based data.

In various embodiments, the internal set of cyber-based protective measures comprises a set of protective protocols within the entity, a set of protective procedures within the entity, and a set of internal protective mechanisms.

In various embodiments, the external set of cyber-based data comprises a set of external protective protocols, a set of external protective procedures, and a set of external protective mechanisms.

In various embodiments, the assessment of cyber-based data exposure comprises assessment of a set of unstructured data associated with the entity.

In various embodiments, the open-source database comprises a set of cyber-based threats associated exposure of cyber-based data of the entity.

In various embodiments, the analysis of the cyber-based data protection exposure of the entity further comprises a set of estimates associated with a set of predetermined categories.

In another aspect, a computer program product assessing cyber-based data protection exposure using artificial intelligence is provided. The computer program product comprises at least one non-transitory computer-readable medium having computer-readable program code portions embodied therein, the computer-readable program code portions comprising: an executable portion configured to compile an assessment of cyber-based data exposure of an entity using an artificial intelligence, said entity comprised of a set of cyber-based data, an internal set of cyber-based protective measures, and an external set of cyber-based protective measures. The computer program code portions further comprise comparing the assessment of cyber-based data exposure against an open-source database. The computer program code portions further comprises generating an analysis of cyber-based data protection exposure associated with the entity based on the comparison of the assessment of cyber-based data exposure against the open source database, wherein the analysis of cyber-based data protection exposure associated with the entity comprises an estimation of exposure of the set of cyber-based data.

In various embodiments, the internal set of cyber-based protective measures comprises a set of protective protocols within the entity, a set of protective procedures within the entity, and a set of internal protective mechanisms.

In various embodiments, the external set of cyber-based protective measures comprises a set of external protective protocols, a set of external protective procedures, and a set of external protective mechanisms.

In various embodiments, the set of cyber-based data comprises a set of data received by the entity from an external source, a set of data transmitted by the entity to the external source, and a set of data stored within the entity.

In various embodiments, the assessment of cyber-based exposure comprises assessment of a set of unstructured data associated with the entity.

In various embodiments, the open-source database comprises a set of cyber-based threats associated with exposure of cyber-based data of the entity.

In various embodiments, the analysis of the cyber-based data protection exposure of the entity further comprises a set of estimates associated with a set of predetermined categories.

In another aspect, a computer-implemented method assessing cyber-based protection exposure using artificial intelligence is provided. In some embodiments, the computer-implemented method comprises: compiling an assessment of cyber-based data exposure of an entity using an artificial intelligence, said entity comprised of a set of cyber-based data, an internal set of cyber-based protective measures, and an external set of cyber-based protective measures. The computer-implemented method may further comprise comparing the assessment of cyber-based data exposure against an open-source database. The computer-implemented method may further include generating an analysis of cyber-based data protection exposure of the entity based on the comparison of the assessment of cyber-based data exposure against the open-source database. The analysis comprises an estimation of exposure of the set of cyber-based data.

In various embodiments, the internal set of cyber-based protective measures comprises a set of protective protocols within the entity, a set of protective procedures with the entity, and a set of internal protective mechanisms.

In various embodiments, the external set of cyber-based protective measures comprises a set of external protective protocols, a set of external protective procedures, and a set of external protective mechanisms.

In various embodiments, the set of cyber-based data comprises a set of data received by the entity from an external source, a set of data transmitted by the entity to the external source, and a set of data stored within the entity.

In various embodiments, the assessment of cyber-based data exposure comprises assessment of a set of unstructured data associated with the entity.

In various embodiments, the analysis of cyber-based data protection exposure of the entity further comprises a set of estimates associated with a set of predetermined categories.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for assessing cyber-based data protection exposure using artificial intelligence in accordance with an embodiment of the disclosure;

FIG. 2 illustrates an exemplary machine learning (ML) subsystem architecture, in accordance with an embodiment of the disclosure;

FIG. 3 illustrates a process flow for assessing cyber-based data protection exposure using artificial intelligence in accordance with an embodiment of the disclosure; and

FIG. 4 illustrates an exemplary assessment of cyber-based data exposure in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As described herein, “exposure” may refer to a measurement of the likelihood an incident, event, action, and/or situation may cause unauthorized manipulation, distribution, and/or mismanagement of cyber-based data at least partially associated with the entity. Increased exposure of cyber-based data may promote data leaks, data loss, destruction of data, loss of resources and/or financial loss. The measurement of exposure may be used in a data management system utilizing predefined rules for the assessment and categorizations of external inputs. In other words, exposure may be used as a measurement for managing insurance claims.

As described herein, “artificial intelligence” may refer to advanced computational models for data analysis and automated decision-making. Artificial intelligence may further include forms of machine learning, machine intelligence, computer aided testing and the like.

The exposure of cyber-based data within an entity may increase as an entity expands. Similarly, as the entity expands the measures associated with the protection of cyber-based data may increase in size and complexity. Estimation of the exposure and the protection of the cyber-based data within the entity may enable the impact of malicious cyber-based activities to be measured, as well as provide insight into protective measures that may mitigate the impact of said malicious cyber-based activities.

The protection of cyber-based data is constantly evolving and changing with the advent of new cyber-based threats and changing procedures, policies, architecture, and framework within an entity. Disruptions to an entity's operations, data leaks, and loss of resources may occur within an entity due to malicious cyber-based activities. Without knowledge or an estimation of the potential impact of increased exposure of cyber-based data, an entity may be unprepared or underequipped to mitigate the wide array of issues resulting from exposed cyber-based data.

Accordingly, the present disclosure comprises assessing the cyber-based data protection exposure of an entity (wherein cyber-based data may include cyber-based resources) within an entity and determining a monetary range associated with the level of protection available (i.e., insurance estimate on cyber-based data). Artificial intelligence/machine learning is used to compile an assessment of the cyber-based protection capabilities of the entity. The assessment determines the value of the cyber-based data associated with the entity as well as the internal and external protective measures utilized by the entity. The compiled assessment is then compared against an open-source database, which may be comprised of a set of cyber based threats associated with exposure of cyber-based data within the entity. The comparison between the assessment and the open-source database generates an analysis of cyber-based data exposure, which may be comprised of an estimation of the exposure of the cyber-based data (i.e., insurance estimate value/range), analysis of the exposure of the entity (i.e., sources of exposure), and a projected model of entity operations in the event of a cyber-based threat.

What is more, the present disclosure provides a technical solution to a technical problem. As described herein, the technical problem includes estimating and identifying the exposure of cyber-based data within an entity. The technical solution presented herein allows for assessing cyber-based data protection exposure using artificial intelligence. In particular, assessing cyber-based data protection exposure using artificial intelligence is an improvement over existing solutions to estimating and identifying the exposure of cyber-based data within an entity, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

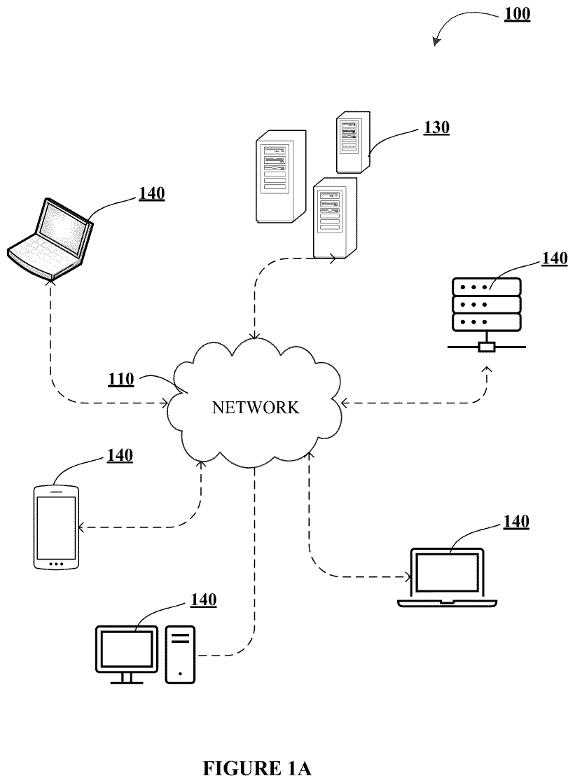

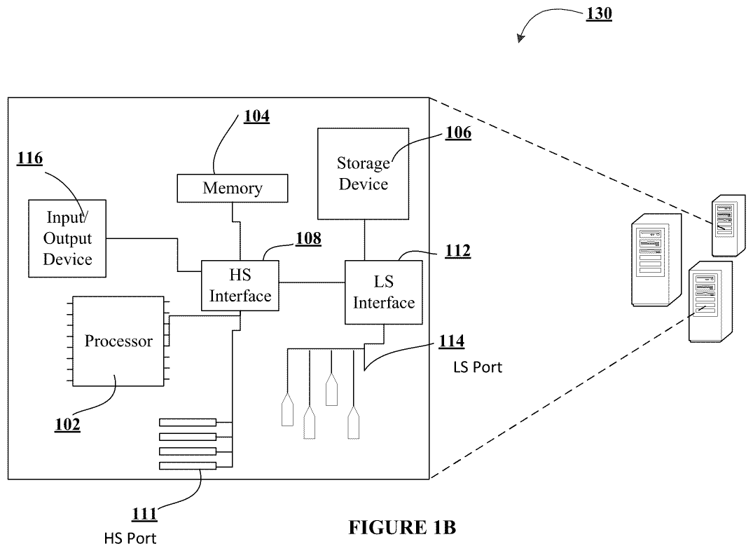

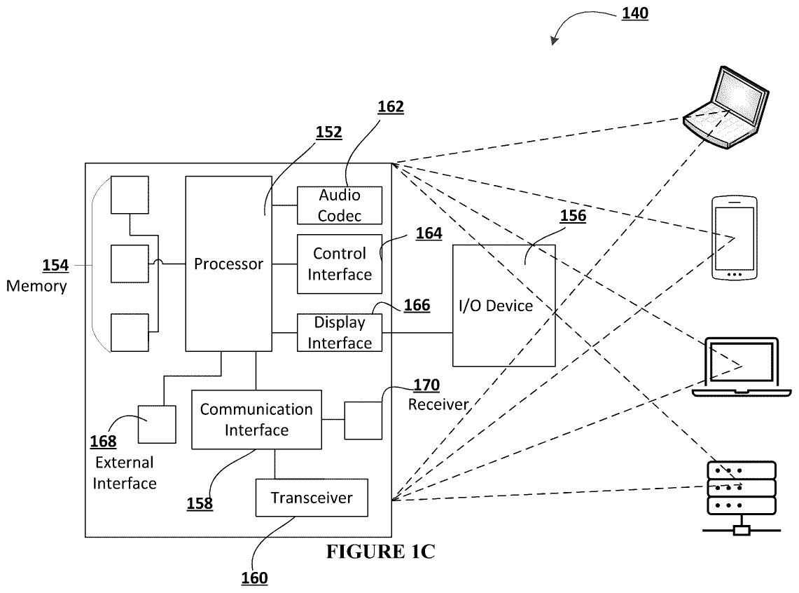

FIGS. 1A-1C illustrate technical components of an exemplary distributed computing environment for assessing cyber-based resource protection exposure using artificial intelligence 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

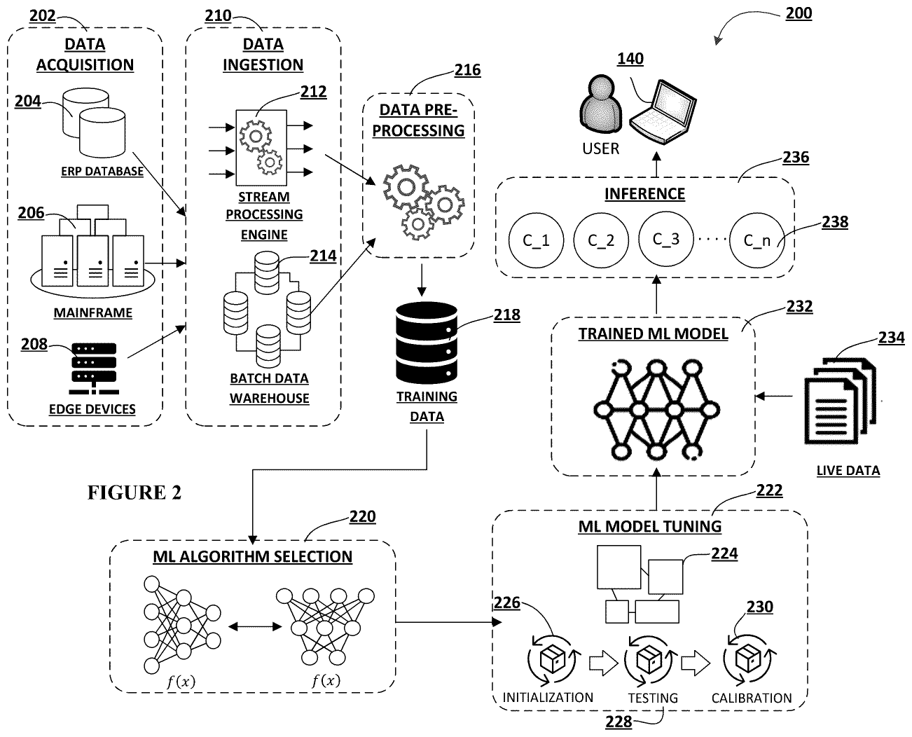

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., Cl, C_2 . . . C_n 238) live data 234 based on how similar they are to one another to solve exploratory challenges where little is known about the data, provide a description or label (e.g., Cl, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

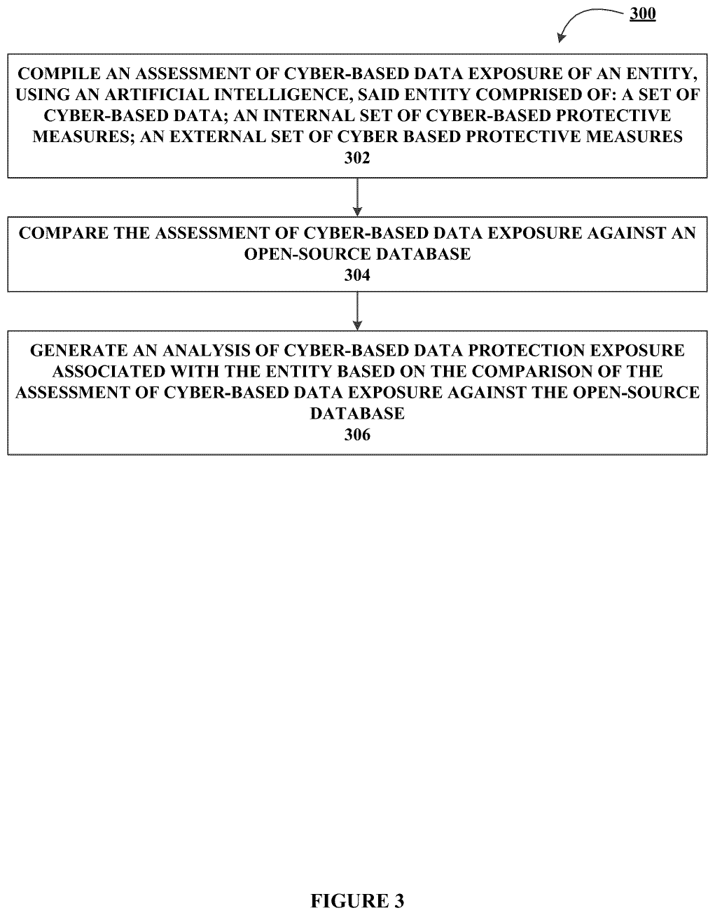

FIG. 3 illustrates a process flow 300 for assessing cyber-based data protection exposure using artificial intelligence, in accordance with an embodiment of the disclosure. In some embodiments, a system and method for assessing cyber-based data protection exposure using artificial intelligence (e.g., similar to one or more of the systems described herein with respect to FIGS. 1A-1C, 2, and 4) may perform one or more of the steps of process flow 300.

As shown in Block 302, the process flow 300 may include the step of compiling an assessment of cyber-based exposure of an entity using an artificial intelligence. The entity may be comprised of a set of cyber-based data, an internal set of cyber-based protective measures, and an external set of cyber-based protective measures. In some embodiments, cyber-based protective measures may include equipment, policies, infrastructure, devices, personnel, networks, systems, security, and/or the like associated with the entity that may at least partially protect and/or prevent computer systems and networks from attack by malicious or external sources. Cyber-based protective measures may further include procedures, protocols, or mechanisms associated with the entity that may protect the entity from malicious actions such as unauthorized information disclosures, interactions, transfers, disruptions, and/or alteration of an entity's operations/equipment. The internal set of cyber-based protective measures may be protective measures at least partially directed towards activity and/or security within the entity. Similarly, the external set of cyber-based protective measures may be measures and/or security directed towards activity originating from outside the entity. The cyber-based protective measures and the set of cyber-based data may be identified within data associated with the entity. Data associated with the entity may be provided by the entity, as described in further detail below.

In some embodiments, assessment of the entity may be an evaluation, determination, and/or estimation of the exposure of the set of cyber-based data and the protection associated with the set of cyber-based data within the entity. The assessment of the entity may provide insight, notes and capabilities of the cyber-based protection programs, procedures, protocols, and mechanisms within the entity. For instance, the assessment may comprise a list of the set of cyber-based data, internal cyber-based protective measures, and external cyber-based protective measures within the entity. The assessment may further include the strength and capabilities of both the internal and external protective measures (i.e., exposure of the cyber-based data to cyber-based threats, such as malware).

In some embodiments, assessment of the entity using artificial intelligence may use data associated with the entity. The data associated with the entity may be provided by the entity, members of the entity, and/or an administration associated with the entity. Data associated with the entity may be used as live data 234 as seen in FIG. 2. As an increasing amount of data associated with the entity is provided to the artificial intelligence, the assessment of the entity may become more accurate. The assessment conducted by the artificial intelligence may further increase the accuracy of its assessment as multiple entities may be assessed. Furthermore, as an increasing amount of data associated with the entity is received as an input, the more cyber-based measures and cyber-based data may be found, increasing the accuracy of the assessment.

In some embodiments, the artificial intelligence may be referred to as machine learning and/or an advanced computational model for data analysis and automated decision making. Artificial intelligence may be used to compile the assessment of the entity and designate data obtained from the assessment as part of the set of cyber-based data, internal set of cyber-based protective measures, and/or an external set of cyber-based protective measures. In some embodiments, the artificial intelligence may use a form of machine learning, as described in FIG. 2. The artificial intelligence may use data associated with the entity to diagnose and identify parts of the entity (i.e., identify data associated with the entity that is cyber-based data, identify data associated with the entity that is considered part of the internal set of cyber-based protective measures, and identify data associated with the entity that is considered part of the external set of cyber-based protective measures).

In some embodiments, the internal set of protective measures may include a set of internal protective protocols, a set of internal protective procedures, and a set of internal protective mechanisms. The set of internal protective protocols may include a set of guidelines or rules associated with cyber-based security directed within an entity. For instance, the set of internal protective protocols may include changing passwords on a periodic basis, cyber-security training of users/personnel within the entity, minimum password lengths, password character diversity (e.g., the inclusion of special characters, numbers, or capital letters), and the like. The internal protective procedures may refer to a predetermined series of steps or actions taken within the entity in response to a cyber-based threat. For instance, the internal protective procedures may include spam filters, responses to cyberattacks, responses to malicious or disguised communication efforts to obtain information, responses to unauthorized interactions, procedures for repeated login attempts, lost password policies, and the like. The set of internal protective mechanisms may include devices within the entity and the capabilities, security, and purposes of said devices. For instance, the internal protective mechanisms within the entity may include mobile phones, laptop computers, routers, desktop computers, servers, data storage units, computer processing units, hardware associated with the entity, software associated with the entity, and the like. The internal set of protective measures may include structures, apparatuses, networks, and devices that protect an entity from malicious actions internally. For instance, the internal set of protective measures may comprise a series of firewalls within an entity, internal communication devices, data storage systems, internal personnel interactions within the entity, cloud data storage systems, and the like.

In some embodiments, the external set of protective measures may include a set of external protective protocols, external protective procedures, and a set of external protective mechanisms. While the internal set of protective measures may be directed towards operations within the entity, the external set of protective measures may be directed towards operations conducted at least partially outside of the entity. For instance, the external protective protocols may include a set of guidelines or rules for receiving electronic messages originating from outside of the entity, sending electronic messages to recipients outside of the entity, sharing of data (such as files, texts, images, videos, etc.) with an outside entity, and the like. The external protective procedures may refer to a series of steps or actions taken when interactions occur that originate outside of the entity or partially take place outside of the entity. For instance, the external protective procedures may include procedures enacted when an unauthorized user originating from outside of the entity attempts to access data within the entity, procedures enacted when an external cyber-based connection is made to the entity (originating from outside of the entity), and the like. External protective mechanisms may include external services/devices that provide enhanced cyber-security and/or protection to the entity, such as network security devices, firewalls provided by an external service, email security gateways, web application firewalls, unified threat management, virtual private network (VPN) devices, and the like.

In some embodiments, the internal set of cyber-based protective measures and the external set of cyber-based protective measures may be measures associated with the set of cyber-based data. The cyber-based protective measures (internal and external) may be measures directed at least partially towards the protection, securement, and/or safeguarding of the set of cyber-based data within the entity. For instance, policies, programs, devices, and/or the like associated with the entity that may contribute to or enhance the cyber-based protection of the set of cyber-based data may be included within the cyber-based protective measures of the entity (internal or external). In some embodiments, the set of cyber-based data may include cyber-based resources. Cyber-based resources may include resources as previously described and their cyber-based representation (i.e., cyber-based resources).

In some embodiments, the set of cyber-based data may include a set of data received by the entity from an external source, a set of data transmitted by the entity to the external source, and a set of data stored within the entity. The external source from which the set of cyber-based data may be transferred may be comprised of a plurality of sources. In other words, the external source may refer to cyber-based data transferred to the entity from a plurality of sources. The external force may be an external entity, external user, or a combination of such. For instance, the set of data received by the entity from the external source may include deposits, suppliers, creditors, data transfers, resource transfers, service providers, and/or the like. Similarly, the set of data transmitted by the entity to the external source may include withdrawals, payments, data transfers, resource transfers and/or the like. The set of data stored within the entity may include cyber-based resources and/or resources that may be designated for future transfer.

In some embodiments, the assessment of cyber-based data exposure may include the analysis of unstructured data within the entity. For instance, the assessment may include analyzing text, dates, numbers, and facts associated with the entity that may be used to determine the cyber-based exposure of the entity. Unstructured data may also be found within both the internal set of cyber-based protective measures and the external set of cyber-based protective measures. In other words, unstructured data may be included within the set of cyber-based data within the assessment of cyber-based data exposure of the entity. Unstructured data may be identified, discovered, or collected using artificial intelligence during the initial assessment of the entity. Unstructured data may further be sorted into the internal set of cyber-based protective measures, external set of cyber-based protective measures, or the set of cyber-based data depending on the contents of the unstructured data.

In some embodiments, the assessment of cyber-based data exposure of the entity may include a set of predetermined categories. The predetermined categories may be segments of the assessment in which the cyber-based data exposure of the entity may be assessed. For instance, the assessment may include categories in which the type of exposure the cyber-based data may be subjected to, the severity of the exposure, factors in which exposure may be mitigated (protective measures within the entity), likelihood of exposure with the current protective measures, and the like. The predetermined categories may enable the analysis of cyber-based data exposure to be viewed in greater detail based on the predetermined category. For instance, a predetermined category (such as external protective mechanisms) may have estimations/analyses specific to the predetermined category, enabling the overall analysis of cyber-based data exposure to be broken down into specific groups for focused analysis.

As shown in Block 304, the process flow 300 may include the step of comparing the assessment of cyber-based data exposure against an open-source database as shown in Block 304. Comparison of the assessment may evaluate the level of exposure to which the entity may be vulnerable. The level of exposure may indicate the likelihood of malicious cyber-based actions directed towards the entity, such as data breaches, delays in operation, and loss of cyber-based data. The open-source database may include malicious cyber-based actions, the way in which the malicious cyber-based actions were implemented, weaknesses in cyber-based protection measures, and the like.

In some embodiments, the open-source database may comprise a set of cyber-based threats associated with exposure of the cyber-based data within the entity. The open-source-database may further comprise a history of cyber-based vulnerabilities, a set of cyber-based attacks, a set of cyber-based attack techniques used against other entities, a set of cyber-security concerns, a set of measures that decrease exposure of cyber-based data, weaknesses/security flaws of cyber-based protective measures, consequences resulting from exposed cyber-based data, and/or compilation of the cyber based protection exposure of previously documented or encountered entities. The open-source database may be updated based on events or experiences of previously encountered entities. For instance, the exposure of an entity may have caused losses, disruptions, and/or data leaks for the entity. The exposure/vulnerability may be recorded on the open-source database, which may then be compared to the assessment of cyber-based data exposure. The open-source database may be updated by third parties, entities, users, or the like. In some embodiments, a plurality of open-source databases may be used. The plurality of open-source databases may comprise cyber-based threats, cyber-based security flaws, threat intelligence data, historical impacts of malicious cyber-based activity, impact on the operations of an entity, and the like. The plurality of open-source databases may be predetermined based on the type of analysis of cyber-based data exposure. For instance, if the analysis of cyber-based data exposure is comprised of cyber-based threats and the monetary impact of said threats, an open-source database comprised of cyber-based threats and an open-source database comprised of historical monetary impact of cyber-based threats may be used during the comparison of the assessment.

In some embodiments, changes associated with the set of cyber-based data and/or cyber-based protective measures within the entity may be documented within the assessment of cyber-based data exposure of the entity. For instance, the implementation of a multi-factor authentication system within the entity to login may be considered a change in the internal set of cyber-based protective measures that reduces exposure of the entity. This reduction of cyber-based data exposure may alter the assessment compiled and may cause a reassessment of the cyber-based data exposure of the entity.

As shown in Block 306, the process flow 300 may include the step of generating an analysis of the cyber-based data protection exposure of the entity based on the comparison of the assessment of cyber-based data exposure against the open-source database. The analysis may include an estimation of exposure of the set of cyber-based data. Estimation of the exposure may include assignment of a numeric value to a set of predetermined categories, which may quantify the extent of the of the exposure of the entity. Estimation/quantification of the exposure of the entity may include a numeric value reflecting the extent of the exposure of the entity when compared to the open-source database. If the open-source database includes an example wherein an entity with similar cyber-based protective measures failed to prevent malicious actions, the cyber-based data exposure may be estimated to reflect a similar scenario to the entity. For instance, a given first entity may have experienced a data leak due to a security flaw in a third-party cyber security system employed by the first entity. The impact on the first entity resulting from this data leak may be recorded on the open-source database by the artificial intelligence. A second entity may then be compared against the first entity, and if the same security flaw is found in the second entity (i.e., if the second entity employs the same third-party cyber security system), then the exposure/impact on the first entity may be used as estimation for the second entity. The exposure estimation may be provided as a range of values or a specific numeric value. The range of values may reflect the minimum and the maximum financial impact due to successful malicious actions.

In some embodiments, the predetermined categories may be used to estimate the financial impact caused by a potential cyber security exposure. The predetermined categories may be used to determine an estimated exposure range in which the potential cyber security exposure may impact the entity through comparison with the open-source database. For instance, an estimate may be subdivided in the analysis, wherein an estimated range is provided from the exposure of a predetermined category. In other words, the estimated exposure may be provided based on a predetermined category as well as the overall exposure of the entity. Estimation of the exposure from each predetermined category may provide insight to the categories within the entity that have the largest exposure to malicious actions.

In some embodiments, the numeric value assigned to the set of predetermined categories may reflect the resource exposure of the entity due to cyber-based data exposure. The resource exposure may include estimations of damages, data leaks/losses, unauthorized data transfers, unauthorized resource transfers, resource losses, cost of delays associated with the operation of the entity, and/or similar expenses incurred due to cyber-based exposure of the entity. The numeric value assigned may be based off a weighting of the predetermined categories. For instance, the numeric value may be based off the internal set of cyber-based protective measures, the external set of cyber-based protective measures, and the set of data within the entity. The predetermined categories may further be used to estimate the financial cost of the cyber data exposure within the entity. For instance, a predetermined category may include costs resulting from exposure of a given set of cyber-based data from internal protective measures. This may include comparison of the amount of exposure of a 6-character password policy for internal personnel vs an 8-character password policy for internal personnel. The exposure of the entity for having lower password complexity may increase the exposure of the entity, thus estimating a higher numeric value/range of values associated with the cost of exposure protection. The set of cyber-based data subjected to exposure within the entity may also be used in the estimation of the financial cost of the cyber-based data exposure within the entity (i.e., segments/parts of the set of cyber-based data may be determined to have a greater financial impact on the entity). In other words, data leaks or exposure may be more damaging if certain cyber-based data within the entity were exposed, and thus parts of the set of cyber-based data may be subjected to different cyber-based protective measures.

In some embodiments the artificial intelligence may estimate the exposure of the set of cyber-based data based on the contents of said cyber-based data. For instance, subsets of the set of cyber-based data may have varying levels of protection, exposure, and/or importance. A first subset of data within the set of cyber-based data may have a different exposure estimation than a second subset of data. The estimations for both subsets may be included within the analysis of the cyber-based exposure of the set of cyber-based data. In other words, the analysis of the cyber-based protection exposure may include an estimate of exposure for the entity overall and provide an estimate for subsets of cyber-based data within the overall estimate.

In some embodiments, the analysis of cyber-based protection exposure of the entity may further comprise a projection of entity operations in the event of a cyber based threat. The analysis may include the differences between the assessment of cyber-based data exposure against the open-source database. The analysis may further be used to suggest measures the entity may implement to reduce exposure of cyber-based data. For instance, the comparison may highlight the deficiencies or weaknesses associated with the cyber-based data protection of the entity, and may provide insights, recommendations, alternatives, suggestions, and/or the like to promote the cyber-based protection of the entity and the cyber-based data/resources within the entity. The projection of entity operations in the event of a cyber-based threat may comprise a model or estimation of cyber-based data protection exposure within the entity and/or the impact of the cyber-based threat on the entity.

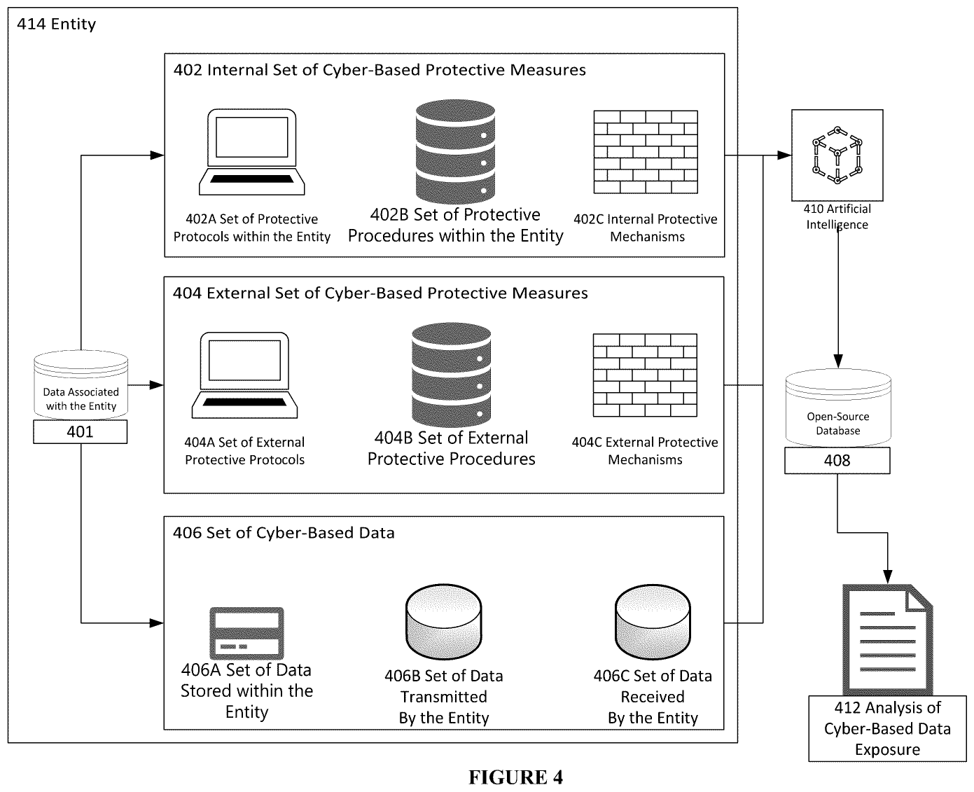

FIG. 4 illustrates an exemplary architecture used to assess cyber-based data protection exposure using artificial intelligence. The architecture used to assess cyber-based data protection exposure 400 may include an entity 414, an open-source database 408, and an artificial intelligence 410, which may be used to generate an analysis of cyber-based data exposure 412. The entity may be comprised of an internal set of cyber-based protective measures 402, an external set of cyber-based protective measures 404, and a set of cyber-based data 406, which may be identified from the data associated with the entity 401 by the artificial intelligence 410. The cyber-based data protection exposure of the entity 414 may be assessed by an artificial intelligence 410 by identifying/analyzing data associated with the entity 401 provided by the entity, members of the entity, personnel associated with the entity, and/or an administration associated with the entity. The assessment of the cyber-based data protection exposure of the entity 414 by the artificial intelligence 410 may then be compared against the open-source database 408.

In some embodiments, the data associated with the entity 401, and the open-source database 408 may be considered live data 234 or training data 218 as seen in FIG. 2. Segments of the data associated with the entity 401 may be identified as part of the internal set of cyber-based protective measures 402, as part of the external set of cyber-based protective measures 404, or as part of the set of cyber-based data 406. The data associated with the entity 401 may further include unstructured data which may be identified and sorted as previously described. Similarly, the artificial intelligence 410 may be representative of the trained machine learning model 232 or the machine learning model tuning engine 222 as seen in FIG. 2. The architecture used to assess cyber-based data protection exposure 400 may be used to generate an analysis of cyber-based data exposure 412 of the entity 414.

Segments, pieces, and parts of the data associated with the entity 401 assessed by the artificial intelligence 410 may be identified as part of (or identified as a subcategory within) the internal set of cyber-based protective measures 402, the external set of cyber-based protective measures 404, or the set of cyber-based data 406. Data associated with the entity 401 may be filtered by the artificial intelligence 410 to retain data identified to relate to data protection exposure within the entity.

In some embodiments, there may be several subcategories within the internal set of cyber-based protective measures 402, the external set of cyber-based protective measures 404, and the set of cyber-based data 406. The internal set of cyber-based protective measures 402 may include a set of protective protocols within the entity 402A, a set of protective procedures within the entity 402B, and internal protective mechanisms 402C. The external set of cyber-based protective measures 404 may include a set of external protective protocols 404A, a set of external protective procedures 404B, and external protective mechanisms 404C. The set of cyber-based data 406 may include cyber-based data stored within the entity 406A, a set of data transferred by the entity 406B, a set of data received by the entity 406C. The assessment of the cyber-based data protection exposure may then be compared to the open-source database 408.

Upon compiling the assessment of cyber-based exposure of an entity 414 using artificial intelligence 410, the assessment may be compared to an open-source database 408. The database may be comprised of cyber-based threats, potential exposure, cyber-based security issues, threat intelligence data, historical impact (monetary or operationally) to an entity, and/or the like. Upon comparison of the assessment to the open-source database 408, an analysis of cyber-based data exposure 412 may be generated.

The analysis of cyber-based data exposure 412 may be comprised of a set of estimates associated with a set of predetermined categories within the entity. The analysis may generate an estimate of the exposure, monetary impact, and/or operational impact for a predetermined category within the entity. For instance, a security flaw found within the internal protective mechanisms 402C may generate an analysis of the exposure of the entity in a predetermined category relating to internal protective mechanisms. An estimated financial impact as well as operational impact to the entity 414 may be provided in the analysis, which may be a part of the overall analysis (e.g., a sub-estimate for the exposure of the internal set of cyber-based protective measures 402 may be compared to the overall exposure of the entity).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system assessing cyber-based data protection exposure using artificial intelligence, the system comprising:
a memory device with computer-readable program code stored thereon;
at least one processing device operatively coupled to the at least one memory device and the at least one communication device, wherein executing the computer-readable code is configured to cause the at least one processing device to perform the following operations:
compile an assessment of cyber-based data exposure of an entity using an artificial intelligence, said entity comprised of:
a set of cyber-based data;
an internal set of cyber-based protective measures;
an external set of cyber-based protective measures;
compare the assessment of cyber-based data exposure against an open-source database; and
generate an analysis of cyber-based data protection exposure associated with the entity based on the comparison of the assessment of cyber-based data exposure against the open-source database,
wherein the analysis of cyber-based data protection exposure associated with the entity comprises an estimation of exposure of the set of cyber-based data.

2. The system of claim 1, wherein the internal set of cyber-based protective measures comprises:
a set of protective protocols within the entity;
a set of protective procedures within the entity; and
a set of internal protective mechanisms.

3. The system of claim 1, wherein the external set of cyber-based protective measures comprises:
a set of external protective protocols;
a set of external protective procedures; and
a set of external protective mechanisms.

4. The system of claim 1, wherein the set of cyber-based data comprises:
a set of data received by the entity from an external source;
a set of data transmitted by the entity to the external source; and
a set of data stored within the entity.

5. The system of claim 1, wherein the assessment of cyber-based data exposure comprises assessment of a set of unstructured data associated with the entity.

6. The system of claim 1, wherein the open-source database comprises a set of cyber-based threats associated with exposure of cyber-based data of the entity.

7. The system of claim 1, wherein the analysis of the cyber-based data protection exposure of the entity further comprises a set of estimates associated with a set of predetermined categories.

8. A computer program product assessing cyber-based data protection exposure using artificial intelligence, the computer program product comprising at least one non-transitory computer-readable medium having computer-readable program code portions embodied therein, the computer-readable program code portions comprising:
an executable portion configured to compile an assessment of cyber-based data exposure of an entity using an artificial intelligence, said entity comprised of:
a set of cyber-based data;
an internal set of cyber-based protective measures;
an external set of cyber-based protective measures;
an executable portion configured to compare the assessment of cyber-based data exposure against an open-source database; and
an executable portion configured to generate an analysis of cyber-based data protection exposure associated with the entity based on the comparison of the assessment of cyber-based data exposure against the open-source database,
wherein the analysis of cyber-based data protection exposure associated with the entity comprises an estimation of exposure of the set of cyber-based data.

9. The computer program product of claim 8, wherein the internal set of cyber-based protective measures comprises:
a set of protective protocols within the entity;
a set of protective procedures within the entity; and
a set of internal protective mechanisms.

10. The computer program product of claim 8, wherein the external set of cyber-based protective measures comprises:
a set of external protective protocols;
a set of external protective procedures; and
a set of external protective mechanisms.

11. The computer program product of claim 8, wherein the set of cyber-based data comprises:
a set of data received by the entity from an external source;
a set of data transmitted by the entity to the external source; and
a set of data stored within the entity.

12. The computer program product of claim 8, wherein the assessment of cyber-based exposure comprises assessment of a set of unstructured data associated with the entity.

13. The computer program product of claim 8, wherein the open-source database comprises a set of cyber-based threats associated with exposure of cyber-based data of the entity.

14. The computer program product of claim 8, wherein the analysis of the cyber-based data protection exposure of the entity further comprises a set of estimates associated with a set of predetermined categories.

15. A computer-implemented method assessing cyber-based protection exposure using artificial intelligence, the computer-implemented method comprising:
compiling an assessment of cyber-based data exposure of an entity using an artificial intelligence, said entity comprised of:
a set of cyber-based data;
an internal set of cyber-based protective measures;
an external set of cyber-based protective measures;
comparing the assessment of cyber-based data exposure against an open-source database; and
generating an analysis of cyber-based data protection exposure of the entity based on the comparison of the assessment of cyber-based data exposure against the open-source database,
wherein the analysis comprises an estimation of exposure of the set of cyber-based data.

16. The computer-implemented method of claim 15, wherein the internal set of cyber-based protective measures comprises:
a set of protective protocols within the entity;
a set of protective procedures within the entity; and
a set of internal protective mechanisms.

17. The computer-implemented method of claim 15, wherein the external set of cyber-based data protective measures comprises:
a set of external protective protocols;
a set of external protective procedures; and
a set of external protective mechanisms.

18. The computer-implemented method of claim 15, wherein the set of cyber-based data comprises:
a set of data received by the entity from an external source;
a set of data transmitted by the entity to the external source; and
a set of data stored within the entity.

19. The computer-implemented method of claim 15, wherein the assessment of cyber-based data exposure comprises assessment of a set of unstructured data associated with the entity.

20. The computer-implemented method of claim 15, wherein the analysis of cyber-based data protection exposure of the entity further comprises a set of estimates associated with a set of predetermined categories.
